(19) United States
(12) Patent Application Publication
(10) Pub. No.: US 2012/0150772 A1
(43) Pub. Date: Jun. 14, 2012

(54) Social Newsfeed Triage

(75) Inventors: Tim Paek, Sammamish, WA (US); Scott Joseph Counts, Seattle, WA (US); Michael Gamon, Seattle, WA (US); Aaron Hoff, Kirkland, WA (US); Max Chickering, Bellevue, WA (US)

(73) Assignee: MICROSOFT CORPORATION, Redmond, WA (US)

(21) Appl. No.: 12/965,587

(22) Filed: Dec. 10, 2010

(51) Int. Cl. G06N 5/02; G06F 15/18

(52) U.S. Cl. 706/12; 706/46

(57) ABSTRACT

A social newsfeed being delivered to a user is triaged. A personalized model is established which predicts the importance to the user of data elements within a current social newsfeed being delivered to the user. The personalized model is established based on implicit actions the user takes in response to receiving previous social newsfeeds. The personalized model is then used to triage the data elements within the current social newsfeed.

### BACKGROUND

The Internet and World Wide Web have propelled the popularity of online social networking to the point where it has become a global phenomenon. A number of different social networking websites exist today which are quite popular. A large and still growing percentage of Internet users worldwide are registered users of, and regularly utilize, one or more of these social networking websites. In fact, Internet users taken as a whole now spend more time on social networking websites than on any other type of website. Due to the popularity of online social networking, a typical registered user of a typical social networking website expands the size of their online social network on a regular basis.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

Social newsfeed triage technique embodiments described herein generally involve triaging a social newsfeed being delivered to a user. In an exemplary embodiment a personalized model is established which predicts the importance to the user of data elements within a current social newsfeed being delivered to the user. The personalized model is established based on implicit actions the user takes in response to receiving previous social newsfeeds. The personalized model is then used to triage the data elements within the current social newsfeed.

### DESCRIPTION OF THE DRAWINGS

The specific features, aspects, and advantages of the social newsfeed triage (SNT) technique embodiments described herein will become better understood with regard to the following description, appended claims, and accompanying drawings where:

FIG. 1 is a flow diagram illustrating an exemplary embodiment, in simplified form, of a process for implementing the SNT technique embodiments described herein.

FIG. 2 is a flow diagram illustrating one embodiment, in simplified form, of a process for establishing a statistical personalized model for predicting the importance to a user of data elements within a current social newsfeed that is being delivered to the user.

FIG. 3 is a flow diagram illustrating another embodiment, in simplified form, of a process for establishing the statistical personalized model.

FIG. 4 is a flow diagram illustrating one embodiment, in simplified form, of a process for establishing a decision tree personalized model for predicting the importance to the user of data elements within the current social newsfeed that is being delivered to the user.

FIG. 5 is a flow diagram illustrating an exemplary embodiment, in simplified form, of a process for triaging the current social newsfeed by generating a personalized summary thereof based on summarization parameters that are specified by the user.

FIG. 6 is a flow diagram illustrating one embodiment, in simplified form, of a process for generating the personalized summary.

FIG. 7 is a flow diagram illustrating another embodiment, in simplified form, of a process for generating the personalized summary.

FIG. 8 is a flow diagram illustrating an exemplary embodiment, in simplified form, of a process for displaying the personalized summary to the user.

FIG. 9 is a diagram illustrating an exemplary system framework, in simplified form, for implementing the SNT technique embodiments described herein.

FIG. 10 is a flow diagram illustrating an exemplary embodiment, in simplified form, of a process for implementing the SNT technique embodiments described herein from the perspective of the system framework exemplified in FIG. 9.

FIG. 11 is a diagram illustrating an exemplary embodiment, in simplified form, of a general purpose, network-based computing device which constitutes an exemplary system for implementing portions of the SNT technique embodiments described herein.

### DETAILED DESCRIPTION

In the following description of social newsfeed triage (SNT) technique embodiments reference is made to the accompanying drawings which form a part hereof, and in which are shown, by way of illustration, specific embodiments in which the SNT technique can be practiced. It is understood that other embodiments can be utilized and structural changes can be made without departing from the scope of the SNT technique embodiments.

The term “registered user” is used herein to refer to an Internet user (and the like) who has an account on a given social networking application. As is appreciated in the art of online social networking, the account of a registered user can include a personal profile, and can also include privacy settings. The personal profile of a registered user generally includes various types of information about the user such as one or more photos of the user, the personal interests of the user, contact information for the user, the user's birthday, and the like. The term “online friend” is used herein to refer to a first registered user of a social networking application who is part of (i.e., a member of) the online social network of a second registered user of the social networking application. Accordingly, in the art of online social networking the first registered user is known as an online friend of the second registered user.

The online friends of a given registered user can have various types of personal relationships with the user. By way of example but not limitation, a given online friend of the user can be a family member, or schoolmate, or work colleague, or personal friend of the user. Additionally, an online friend of a registered user may have no personal relationship with the user at all, but rather may be someone who is interested in “following” the user (as is often the case when the user is a celebrity or the like); this particular type of online friend is sometimes referred to as an “online follower.” The mechanisms by which one registered user becomes an online friend (i.e., is added to the online social network) of another registered user, or one registered user is “de-friended” (also known as being “unfriended”) by another registered user, are well understood and thus need not be described in more detail. The privacy settings of a registered user generally allow the user to specify which information from their personal profile can be shared automatically with their online friends.

### 1.0 Social Newsfeeds

A large and still growing percentage of Internet users worldwide regularly utilize one or more social networking applications. Generally speaking, a given social networking application provides registered users thereof with a prescribed set of services that allow the users to automatically exchange online information content (hereafter simply referred to as “content”) with each of their online friends. More particularly, each registered user of a social networking application can post various types of content that they want their online friends to be aware of. As will be described in more detail hereafter, the application stores the posted content and then automatically delivers it to each online friend of the user in the form of a social newsfeed. The user can utilize this content posting mechanism to inform their online friends of their current “status” (i.e., their current thoughts and feelings, current whereabouts, current activities, and the like), among other things. The content posted by a given registered user can include many different types of data and can be in many different forms. Exemplary types of data include text, images, audio and video, among others, as well as links (such as URLs (uniform resource locators) and the like) to any of these data types. Exemplary forms of data include a message, a blog entry, a photo, a graphical rendering, an audio recording, a video recording, a podcast, a classified ad, and a virtual gift, among others.

Generally speaking and as appreciated in the arts of the Internet and World Wide Web, a newsfeed is an online feed (i.e., an encapsulated online data stream) that includes one or more data elements which can be aggregated from different sources. As is appreciated in the art of online social networking, a conventional social networking application routinely (i.e., at a prescribed interval) checks the account of each online friend of a given registered user for new content the online friend has posted, changes the online friend has made to their personal profile, and upcoming events that are specified within the account that the registered user may be interested in (such as the online friend's birthday, among other events). The application then aggregates any such new content, personal profile changes and upcoming events that it finds in each online friend's account. The application then delivers the aggregated content/changes/events to the registered user in the form of a social newsfeed which is generally displayed on the home page of the user whenever they login to their account on the application. Each content item, personal profile change and upcoming event that is included in the social newsfeed is referred to hereafter as a “newsfeed data element.” Newsfeed data elements are ordinarily delivered to the user by the application in reverse chronological order.

As is further appreciated in the art of online social networking, when a given registered user of a social networking application logs into their account and views the social newsfeed being delivered to them, they can post their own content (such as a comment, among other things) in response to viewing any data element within the newsfeed. As such, the social newsfeed delivered to a given registered user can and generally does include “conversations” that are taking place between the various members of the user's social network. Additionally, upon viewing a given data element that is included within the social newsfeed, if the user finds the data element to be newsworthy, or useful, or interesting, or relevant, or any combination thereof, they can inform the application of this fact by selecting a “Like” button that the application can display within the data element.

As is yet further appreciated in the art of online social networking, due to the aforementioned popularity of online social networking, registered users of a social networking application generally expand the size of their social network (i.e., increase the number of online friends they have) on a regular basis. Consequently, the number of newsfeed data elements the users regularly receive can grow exponentially.

### 2.0 Social Newsfeed Triage

Generally speaking, the SNT technique embodiments described herein involve triaging a social newsfeed that is being delivered to a registered user (hereafter simply referred to as a “user”) of a given social networking application. This triaging can be accomplished in various ways which will be described in more detail hereafter. It is noted that the SNT technique embodiments are operational with any social networking application including, but not limited to, Facebook, Twitter and LinkedIn.

The SNT technique embodiments described herein are advantageous for a variety of reasons including, but not limited to, the following. The SNT technique embodiments sort and prioritize the data elements within the social newsfeed that is being delivered to the user, thus reducing the quantity and enhancing the quality of the newsfeed data elements that are delivered to the user at any given point in time. In other words, the SNT technique embodiments deliver to the user just the newsfeed data elements that are predicted to have a high degree of importance to the user (e.g., the data elements that they find to be newsworthy, or useful, or interesting, or relevant, or any combination thereof). The SNT technique embodiments hide from the user the newsfeed data elements that are predicted to have a low degree of importance to the user. Thus, the SNT technique embodiments serve to optimize the user's experience when they are viewing the social newsfeed. This optimizes the users' satisfaction with investing their time and effort in online social networking activities, which in turn enhances the financial and social networking success of the social networking application.

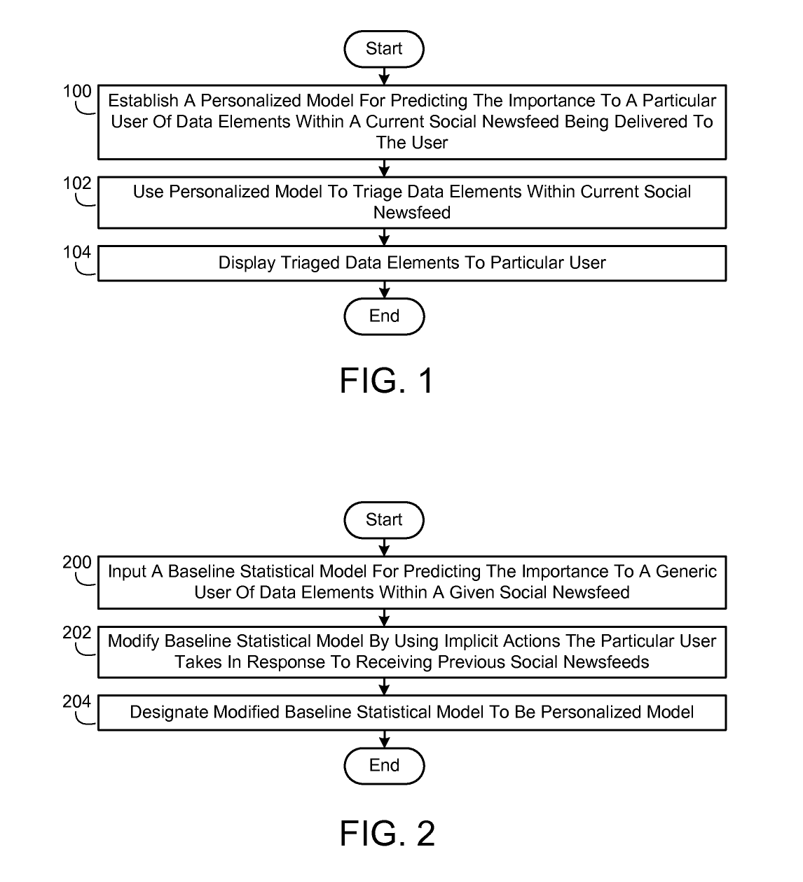

FIG. 1 illustrates an exemplary embodiment, in simplified form, of a process for implementing the SNT technique embodiments described herein. As exemplified in FIG. 1, the process starts in block 100 with establishing a personalized model for predicting the importance to a particular user of data elements within a current social newsfeed that is being delivered to the user. As will be appreciated from the more detailed description that follows, this personalized model is a predictive model in that it ranks each data element within the current social newsfeed in terms of the perceived importance of the data element to the particular user, and also ranks each online friend of the user in terms of the perceived importance of the friend to the user. In other words, the personalized model ranks how interested the particular user is in reading content authored by each of their online friends. As will be described in more detail hereafter, in an exemplary embodiment of the SNT technique the personalized model is established over time based on implicit actions the particular user takes in response to receiving previous social newsfeeds. The personalized model can be established in a variety of ways which will be described in more detail hereafter. Once the personalized model has been established (block 100), it is used to triage the data elements within the current social newsfeed (block 102). This triaging can be performed in a variety of ways which will also be described in more detail hereafter. Once the data elements within the current social newsfeed have been triaged (block 102), the triaged data elements are then displayed to the particular user (block 104).

### 2.1 Establishing Personalized Model

Generally speaking, the SNT technique embodiments described herein can establish two different types of personalized models, namely a personalized model that is a statistical model (herein referred to as a “statistical personalized model”) and a personalized model that is a rule-based decision tree model (herein referred to as a “decision tree personalized model”). This section provides a more detailed description of various ways of establishing both of these types of personalized models.

FIG. 2 illustrates one embodiment, in simplified form, of a process for establishing a statistical personalized model. As exemplified in FIG. 2, the process starts in block 200 with inputting a general baseline statistical model for predicting the importance to a generic user of data elements within a given social newsfeed, where this baseline statistical model is trained based on explicit actions other users take in response to receiving previous social newsfeeds. Since the baseline statistical model is trained based on the explicit actions of a plurality of different users, the baseline statistical model is not user-specific. As is appreciated in the art of machine learning a variety of learning techniques can be used to train the baseline statistical model. One such learning technique is the conventional support vector machine (SVM) method. The baseline statistical model is then modified by using the implicit actions the particular user takes in response to receiving previous social newsfeeds (block 202). In other words, machine learning (such as the SVM method and the like) is used to analyze these implicit actions, and the analysis results are used to modify the baseline statistical model. The modified baseline statistical model is then designated to be the personalized model (block 204). This particular method for establishing the personalized model is advantageous in that it allows the SNT technique embodiments described herein to quickly bootstrap to the particular user in the situation where there is a scarcity of implicit action information for the particular user (e.g., when the particular user is a new user of the social networking application).

In one embodiment of the SNT technique described herein the aforementioned “other users” (whose explicit actions are used to train the baseline statistical model) can simply be all of the users of the social networking application. Other embodiments of the SNT technique are also possible where the other users can be a subset of the application users who are similar to the particular user in one or more prescribed ways. By way of example but not limitation, the other users can be users who generate newsfeed data elements having one or more words or word phrases in common with newsfeed data elements generated by the particular user. Such word or word-phrase commonality can be an indication that the other users share a common interest with the particular user. As is appreciated in the art of language modeling, n-grams are an exemplary method of measuring word or word-phrase commonality. The other users can also be users who have one or more online friends in common with the particular user. The other users can also be users who have a pattern of explicit actions in common (e.g., share a common behavior pattern) with the particular user, where these actions are in response to viewing a social newsfeed. Various patterns of explicit actions can be measured to determine such a commonality. One exemplary pattern of explicit actions that can be measured is the frequency by which a given user posts their own content (such as a comment, among other things) in response to viewing their social newsfeed. Another exemplary pattern of explicit actions that can be measured is the types of links a given user selects in response to viewing their social newsfeed. Yet another exemplary pattern of explicit actions that can be measured is the types of newsfeed data elements a given user requests more detail about in response to viewing their social newsfeed.

The implicit actions the particular user may take in response to a given social newsfeed being delivered to the user generally include implicit data element relevance feedback signals which are provided by the user. These feedback signals provide implicit evidence that the particular user found a particular newsfeed data element they viewed to have a high degree of importance to themself. Examples of these feedback signals include, but are not limited to, the particular user commenting on a particular social newsfeed data element that they view, the particular user selecting the aforementioned “Like” button that the social networking application displays within a particular social newsfeed data element that they view, the particular user selecting a link that is displayed within a particular social newsfeed data element, and the particular user forwarding a particular social newsfeed data element to another user.

In one embodiment of the SNT technique described herein the baseline statistical model is a conventional Facebook EdgeRank model. In another embodiment of the SNT technique the baseline statistical model is a conventional learned social newsfeed content and online friend importance model.

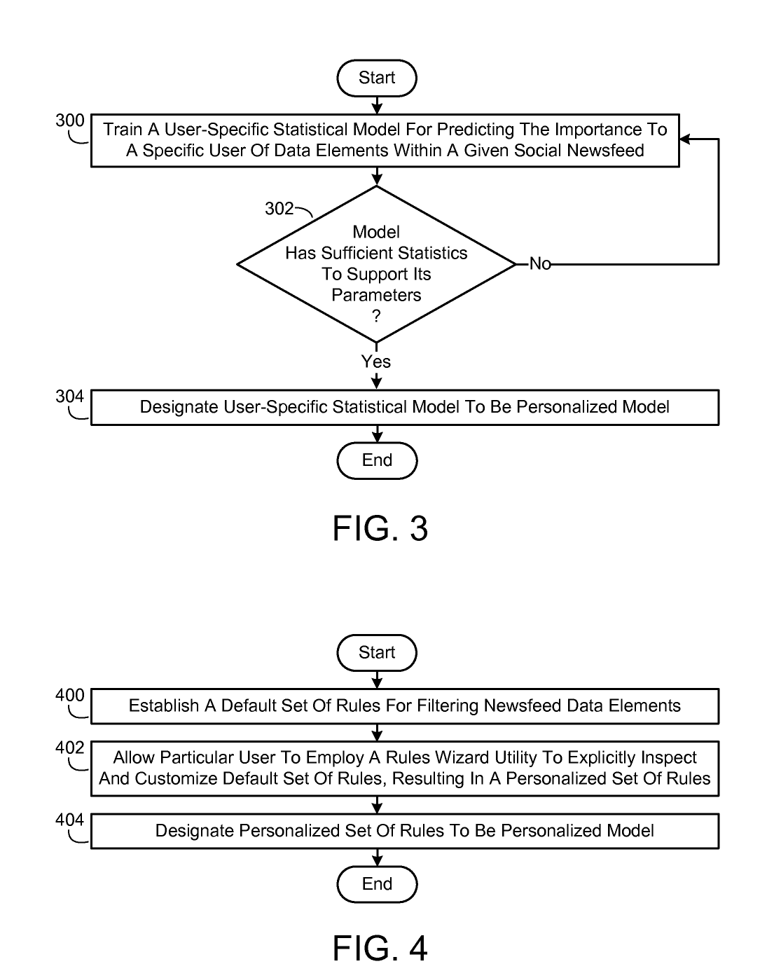

FIG. 3 illustrates another embodiment, in simplified form, of a process for establishing a statistical personalized model. Rather than starting off with a baseline statistical model as just described, in this particular embodiment the personalized model is gradually created “from scratch” in the following manner. As exemplified in FIG. 3, the process starts in block 300 with training a user-specific statistical model for predicting the importance to a specific user of data elements within a given social newsfeed, where this training is based on the implicit actions the particular user takes in response to receiving previous social newsfeeds. In other words, machine learning (such as the SVM method and the like) is used to analyze these implicit actions, and the analysis results are used to train the user-specific statistical model. The training (block 300) continues until the user-specific statistical model has sufficient statistics to support the parameters on which the user-specific statistical model is based (block 302, Yes), at which point the user-specific statistical model is designated to be the personalized model (block 304).

FIG. 4 illustrates one embodiment, in simplified form, of a process for establishing a decision tree personalized model. As exemplified in FIG. 4, the process starts in block 400 with establishing a default set of one or more rules for filtering newsfeed data elements. The default set of rules can be established in a variety of ways including, but not limited to, the following. In one embodiment of the SNT technique described herein, the particular user employs a conventional “Rules Wizard” utility to create the default set of rules. As is appreciated in the art of personal computing, the Rules Wizard utility generally provides the user the ability to specify prescribed conditions for filtering newsfeed data elements and to specify what actions they want to be performed on data elements that meet the conditions. Rules Wizard utilities, such as those used to establish a set of email filtering rules in a conventional email application (such as Mozilla Thunderbird™ (a trademark of the Mozilla Foundation) among others) are well understood in the art of personal computing and thus need not be described in more detail. In another embodiment of the SNT technique, the default set of rules are trained based on the implicit actions the particular user takes in response to receiving previous social newsfeeds. In other words, machine learning (such as the SVM method and the like) is used to analyze these implicit actions, and the analysis results are then used to train the default set of rules. In an exemplary embodiment of the SNT technique the default rules that are established by this training can optionally be constrained to fit a set of default rule categories that are specified by the Rules Wizard utility.

Referring again to FIG. 4, once the default set of one or more rules for filtering newsfeed data elements have been established (block 400), the particular user is allowed to employ the Rules Wizard utility to explicitly inspect and customize the default set of rules, resulting in a personalized (i.e., user-customized) set of rules (block 402). In other words, the particular user can employ the Rules Wizard utility to constrain the default set of rules to particular parameters that the user is interested in. The personalized set of rules is then designated to be the personalized model (block 404).

One example of a personalized rule for filtering newsfeed data elements, among various possible examples, is the following: “Upon my receiving a newsfeed data element posted by ‘Bob Smith’, classify the data element as unimportant unless it includes the text ‘TOPIC: ME’ or ‘twitter’ or ‘facebook’.” Another example of a personalized rule is the following: “Upon my receiving a newsfeed data element posted by ‘Bob Smith’, classify the data element as unimportant unless it includes the text ‘science’ and it is sent just to me and not anyone else.”

It is noted that once a personalized model for a particular user is initially established (using any of the SNT technique embodiments described herein), the personalized model will generally be successively updated using any implicit actions the user may take in response to future social newsfeeds being delivered to the user. Additionally, since the user is able to, at will, explicitly inspect and customize the newsfeed data element filtering rules associated with the decision tree personalized model, the user can adapt the filtering rules as the user's social newsfeed interests change. Thus, the personalized model for each user generally becomes more accurate as the user continues to utilize the social networking application.

### 2.2 Using Personalized Model to Triage Social Newsfeed

This section provides a more detailed description of various ways in which the aforementioned personalized model can be used to triage the data elements within the current social newsfeed that is being delivered to the particular user.

Generally speaking, as opposed to the newsfeed data elements being delivered to the user by in reverse chronological order as described heretofore, the SNT technique embodiments described herein can sort (e.g., rank order) the newsfeed data elements in various ways. More particularly, in one embodiment of the SNT technique the data elements within the current social newsfeed are sorted according to their importance to the particular user as predicted by the personalized model. In other words, newsfeed data elements which the personalized model predicts to have the highest degree of importance to the particular user are delivered to the user first, and those which the personalized model predicts to have the lowest degree of importance to the user are delivered to the user last. In another embodiment of the SNT technique the data elements are sorted according to their importance to the particular user, as predicted by the personalized model, along a prescribed dimension of the personalized model. In yet another embodiment of the SNT technique the data elements are sorted according to their importance to the particular user, as predicted by the personalized model, along a combination of two or more different prescribed dimensions of the personalized model. Such prescribed dimensions map to the implicit actions the particular user takes in response to receiving previous social newsfeeds. Examples of these prescribed dimensions include, but are not limited to, shareability (sort the data elements by the prediction of how likely the particular user is to share them with their online friends), comment-worthiness (sort the data elements by the predicted worthiness to the particular user of comments they may include) and link-interestingness (sort the data elements by the predicted interestingness to the particular user of links they may include).

Generally speaking, the SNT technique embodiments described herein can also filter the newsfeed data elements in various ways. In other words, newsfeed data elements which the personalized model predicts to be unimportant to the particular user (e.g., data elements which the personalized model predicts to have a degree of importance to the particular user that is below a prescribed threshold) can be filtered out of the current social newsfeed in various ways. More particularly, in one embodiment of the SNT technique described herein data elements that the personalized model predicts to be unimportant to the particular user are removed from the current social newsfeed. In another embodiment of the SNT technique data elements that the personalized model predicts to be unimportant to the particular user along a prescribed dimension of the personalized model are removed from the current social newsfeed. In yet another embodiment of the SNT technique data elements that the personalized model predicts to be unimportant to the particular user along a combination of two or more different prescribed dimensions of the personalized model are removed from the current social newsfeed. Examples of such prescribed dimensions are the same as those provided heretofore. It will be appreciated that in each of these embodiments the filtered set of newsfeed data elements are generally delivered to the particular user in reverse chronological order. It will also be appreciated that data elements which are removed from the current social newsfeed can be either deleted or stored in a prescribed place (such as a “folder,” and the like).

As is appreciated in the art of document summarization, various methods exist for automatically summarizing the textual content of either a single document or a plurality of documents. One particular example of such a document summarization method, among various possible examples, is the conventional statistical summarization method which is well understood in the art of document summarization. Another particular example of such a document summarization method is the conventional extractive summarization method which extracts particular text (such as word, phrases and the like) from a prescribed collection of documents, and then assembles the extracted text into a summarization of the documents without adding any new text. SNT technique embodiments will now be described which employ these document summarization methods to triage a social newsfeed being delivered to a particular user by generating a personalized summary of the newsfeed based on summarization parameters that are specified by the particular user.

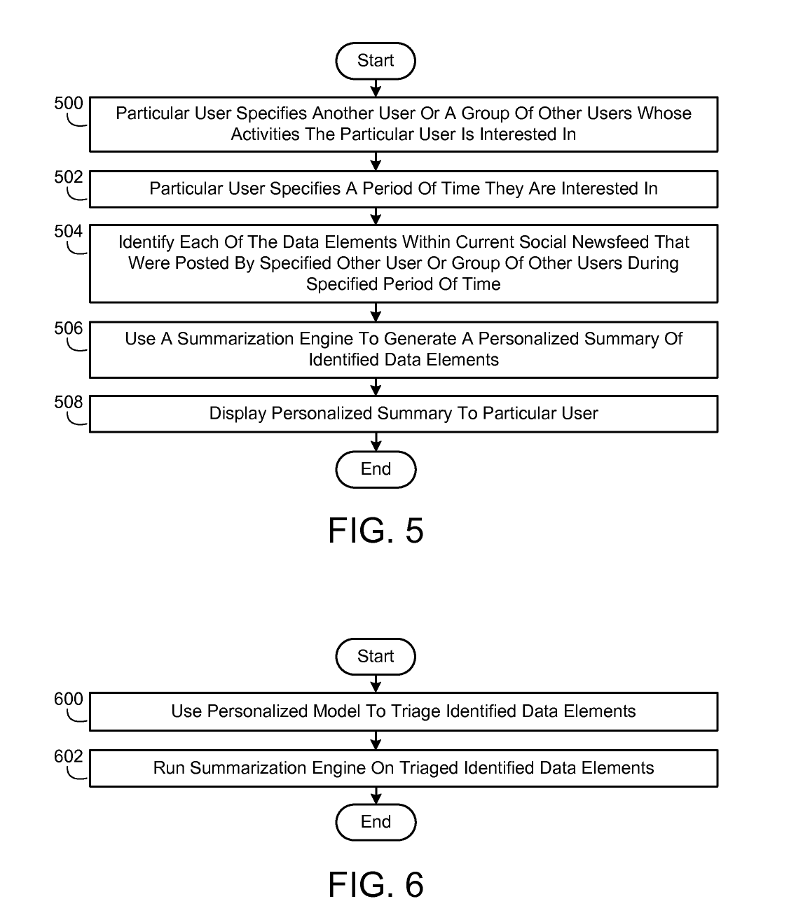

FIG. 5 illustrates an exemplary embodiment, in simplified form, of a process for triaging the current social newsfeed being delivered to a particular user by generating a personalized summary of the newsfeed based on summarization parameters that are specified by the particular user. As exemplified in FIG. 5, the process starts in block 500 with the particular user specifying another user or a group of other users whose activities the particular user is interested in. The particular user also specifies a period of time they are interested in (block 502), where this period of time can either be “forever” (i.e., the entire duration of time for which newsfeed data elements are available on the social networking application), or a time period that is less than this. Each of the data elements within the current social newsfeed that were posted by the specified other user or group of other users during the specified period of time are then identified (block 504). A summarization engine is then used to generate a personalized summary of the identified data elements (block 506), where this generation can be performed in various ways that will be described in more detail hereafter. It will be appreciated that this personalized summary includes a summarization of the textual content of the identified data elements within the current social newsfeed that were posted by the specified other user or group of other users during the specified period of time. The personalized summary is then displayed to the particular user (block 508).

Generally speaking, the summarization engine can implement a variety of document summarization methods. More particularly, in one embodiment of the SNT technique described herein the summarization engine implements the aforementioned conventional extractive summarization method. One particular example of such an extractive summarization method, among various possible examples, is the conventional Pythy summarizer. In another embodiment of the SNT technique the summarization engine implements the aforementioned conventional statistical summarization method.

FIG. 6 illustrates one embodiment, in simplified form, of a process for generating a personalized summary of the identified data elements (i.e., the data elements within the current social newsfeed that are identified to be posted by the other user or group of other users specified by the particular user during the period of time specified by the particular user). As exemplified in FIG. 6, the process starts in block 600 with using the personalized model to triage the identified data elements. The summarization engine is then run on the triaged identified data elements (block 602).

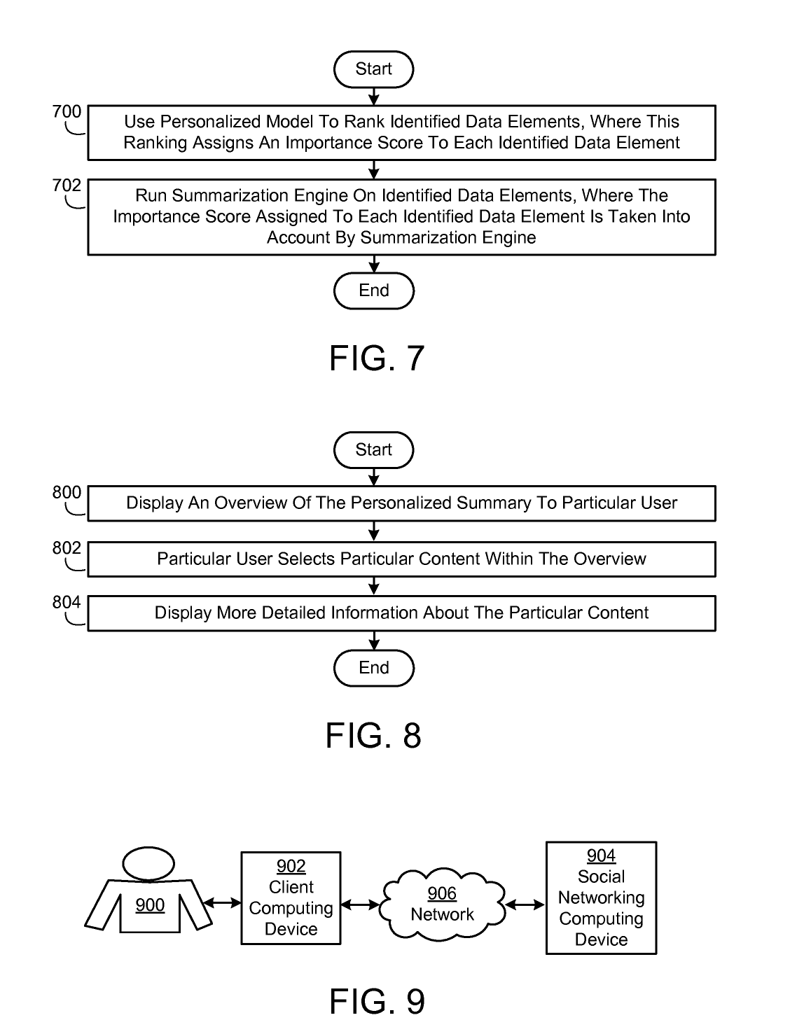

FIG. 7 illustrates another embodiment, in simplified form, of a process for generating a personalized summary of the identified data elements. As exemplified in FIG. 7, the process starts in block 700 with using the personalized model to rank the identified data elements, where this ranking assigns an importance score to each identified data element. The importance score for a given identified data element indicates the predicted importance to the particular user of the identified data element. The summarization engine is then run on the identified data elements, where the importance score assigned to each identified data element is taken into account by the summarization engine (block 702). In other words, the summarization engine employs the importance scores as one of the “features” in its summarization processing.

The personalized summary of the identified data elements that is generated by the summarization engine is structured in a hierarchical manner such that it can be presented to the particular user in increasing levels of detail. In other words, the particular user can choose to see increasingly detailed levels of information about particular content in the personalized summary that they are interested in by selecting such content. By way of example but not limitation, consider a scenario where the particular user is interested in finding out what their online friends from high school have been up to since graduation. Upon the particular user specifying this group of online users and specifying the period of time from graduation to present, the following personalized summary of the particular user's social newsfeed is displayed to the particular user: “John Smith and Mary Clark got married. Joe Blank changed his job. Your wife commented on posts made by Suzie Lee.” To see more detailed information about the marriage, the particular user can select this item in the personalized summary, upon which the following information is displayed to the particular user: “John Smith married Mary Clark on Oct. 17, 2010 in Billings, Mont . . . Your wife commented on their honeymoon pictures here.” The particular user can then select the hyperlink associated with the word “here” in order to see his wife's comments on the honeymoon pictures.

FIG. 8 illustrates an exemplary embodiment, in simplified form, of a process for displaying the personalized summary to the particular user. As exemplified in FIG. 8, the process starts in block 800 with an overview of the personalized summary being displayed to the particular user. Then, upon the particular user selecting particular content within the overview (block 802), more detailed information about the particular content is displayed (block 804).

### 2.3 System Framework

FIG. 9 illustrates an exemplary system framework, in simplified form, for implementing the SNT technique embodiments described herein. As exemplified in FIG. 9, a user 900 uses a client computing device 902 to access a social networking computing device 904 which runs a social networking application. The client and social networking computing devices 902 and 904 are interconnected by a distributed communication network 906. As is appreciated in the art of communication networks, the network 906 can be either a public communication network such as the Internet (among others), or a private communication network such as an intranet (among others). Generally speaking, the user 900 inputs social networking related information (among other types of information) into the client 902, and this input information is provided over the network 906 to the social networking application running on the social networking computing device 904. The client 902 also receives social networking related information (among other types of information) over the network 906 from the social networking application running on the social networking computing device 904. The client 902 can deliver this received information to the user 900 in a variety of ways such as displaying it to user, among others. An exemplary embodiment of how the client 902 interacts with the social networking application running on the social networking computing device 904 will now be described.

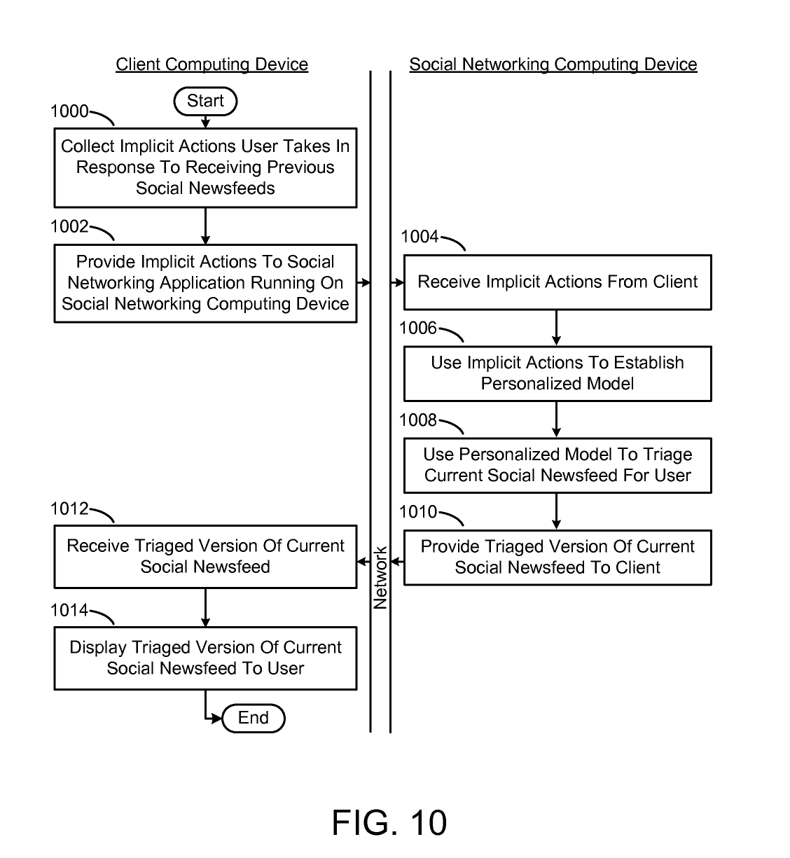

FIG. 10 illustrates an exemplary embodiment, in simplified form, of a process for implementing the SNT technique embodiments described herein from the perspective of the system framework exemplified in FIG. 9. As exemplified in FIG. 10, the process starts in block 1000 with the client computing device collecting the implicit actions the user takes in response to receiving previous social newsfeeds. The client then provides these implicit actions to the social networking application running on the social networking computing device (block 1002) for the establishment of the aforementioned personalized model. The social networking application then receives the implicit actions from the client (block 1004) and uses them to establish the personalized model (block 1006). The social networking application then uses the personalized model to triage the current social newsfeed for the user (block 1008). The social networking application then provides the triaged version of the current social newsfeed to the client (block 1010). The client then receives the triaged version of the current social newsfeed from the social networking application (block 1012) and displays it to the user (block 1014).

### 3.0 Additional Embodiments

While the SNT technique has been described by specific reference to embodiments thereof, it is understood that variations and modifications thereof can be made without departing from the true spirit and scope of the SNT technique. By way of example but not limitation, in the case where the user's client computing device includes a video camera which is generally aimed at the user's face, the video camera can capture a video stream of the user's face and the client can process the video stream to track where on the client's display device the user's eyes are gazing at each point in time. Whenever the user's eyes dwell on a particular spot on the display device for a period of time, the client can compute this period of time. Such eye gaze dwell information can then be used as another one of the implicit data element relevance feedback signals which are provided by the user. Additionally, these signals can also include the user's acceptance or rejection of particular events or particular friend requests. Furthermore, in addition to the Rules Wizard utility being used by the user to explicitly inspect and customize the default set of rules for filtering newsfeed data elements, the user can also use this utility to specify one or more particular actions to be automatically taken and the circumstances under which they are to be taken. By way of example but not limitation, the user may specify that all links which they forward to other users be archived.

It is also noted that any or all of the aforementioned embodiments can be used in any combination desired to form additional hybrid embodiments. Although the SNT technique embodiments have been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

### 4.0 Computing Environment

This section provides a brief, general description of a suitable computing system environment in which portions of the SNT technique embodiments described herein can be implemented. These SNT technique embodiments are operational with numerous general purpose or special purpose computing system environments or configurations. Exemplary well known computing systems, environments, and/or configurations that can be suitable include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the aforementioned systems or devices, and the like.

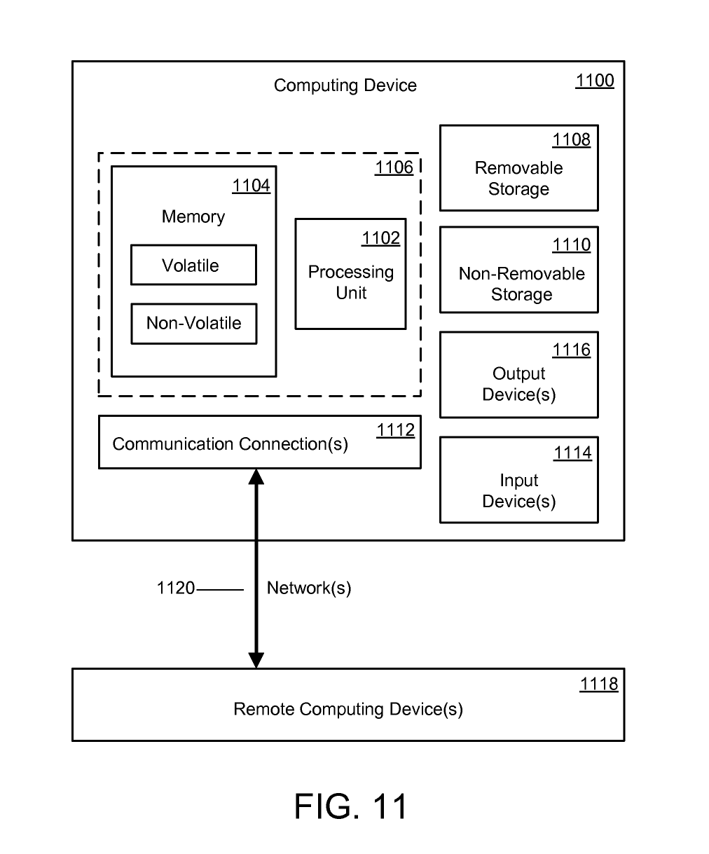

FIG. 11 illustrates an exemplary embodiment, in simplified form, of a suitable computing system environment according to the SNT technique embodiments described herein. The environment illustrated in FIG. 11 is only one example of a suitable computing system environment and is not intended to suggest any limitation as to the scope of use or functionality of the SNT technique embodiments described herein. Neither should the computing system environment be interpreted as having any dependency or requirement relating to any one or combination of components exemplified in FIG. 11.

As exemplified in FIG. 11, an exemplary system for implementing portions of the SNT technique embodiments described herein includes one or more computing devices, such as computing device 1100. In its simplest configuration, computing device 1100 typically includes at least one processing unit 1102 and memory 1104. Depending on the specific configuration and type of computing device, the memory 1104 can be volatile (such as RAM), non-volatile (such as ROM and flash memory, among others) or some combination of the two. This simplest configuration is illustrated by dashed line 1106.

As exemplified in FIG. 11, computing device 1100 can also have additional features and functionality. By way of example, computing device 1100 can include additional storage such as removable storage 1108 and/or non-removable storage 1110. This additional storage includes, but is not limited to, magnetic disks, optical disks and tape. Computer storage media typically embodies volatile and non-volatile media, as well as removable and non-removable media implemented in any method or technology. The computer storage media provides for storage of various information needed to operate the device 1100 such as computer readable instructions associated with an operating system, application programs and other program modules, and data structures, among other things. Memory 1104, removable storage 1108 and non-removable storage 1110 are all examples of computer storage media. Computer storage media includes, but is not limited to, RAM, ROM, EEPROM, flash memory or other memory technology, CD-ROM, digital versatile disks (DVD) or other optical disk storage technology, magnetic cassettes, magnetic tape, magnetic disk storage or other magnetic storage devices, or any other medium which can be used to store the desired information and which can be accessed by computing device 1100. Any such computer storage media can be part of computing device 1100.

As exemplified in FIG. 11, computing device 1100 also includes a communications connection(s) 1112 that allows the device to operate in a networked environment and communicate with a remote computing device(s), such as remote computing device(s) 1118. Remote computing device(s) 1118 can be any of the aforementioned computing systems, environments, and/or configurations, or can be a router, a peer device, or other common network node, and typically includes many or all of the elements described herein relative to computing device 1100. Communication between computing devices takes place over a network(s) 1120, which provides a logical connection(s) between the computing devices. The logical connection(s) can include one or more different types of networks including, but not limited to, a local area network(s) (LAN) and wide area network(s) (WAN). Such networking environments are commonplace in conventional offices, enterprise-wide computer networks, intranets and the Internet. It will be appreciated that the communications connection(s) 1112 and related network(s) 1120 described herein are exemplary and other means of establishing communication between the computing devices can be used.

As exemplified in FIG. 11, communications connection(s) 1112 and related network(s) 1120 are an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, radio frequency (RF), infrared, frequency modulation (FM) radio and other wireless media. The term “computer-readable medium” as used herein includes both the aforementioned storage media and communication media.

As exemplified in FIG. 11, computing device 1100 also includes a user interface which includes one or more input devices 1114 and one or more output devices 1116. Exemplary input devices 1114 include, but are not limited to, a keyboard, mouse, pen, touch input device, audio input device (such as a microphone and the like), and camera, among others. A user can enter commands and various types of information into the computing device 1100 through the input device(s) 1114. Exemplary output devices 1116 include, but are not limited to, a display device(s), printer, and audio output devices (such as one or more loudspeakers, headphones, and the like), among others. These input and output devices are well known and need not be described at length here.

Referring again to FIG. 11, the SNT technique embodiments described herein can be further described and/or implemented in the general context of computer-executable instructions, such as program modules, which are executed by computing device 1100. Generally, program modules include routines, programs, objects, components, and data structures, among other things, that perform particular tasks or implement particular abstract data types. The SNT technique embodiments can also be practiced in a distributed computing environment where tasks are performed by one or more remote computing devices 1118 that are linked through a communications network 1112/1120. In a distributed computing environment, program modules can be located in both local and remote computer storage media including, but not limited to, memory 1104 and storage devices 1108/1110. Still further, the aforementioned instructions could be implemented, in part or in whole, as hardware logic circuits, which may or may not include a processor.

Wherefore, what is claimed is:

1. A computer-implemented process for triaging a social newsfeed being delivered to a particular user, comprising:
using a computer to perform the following process actions:
establishing a personalized model for predicting the importance to the particular user of data elements within a current social newsfeed being delivered to the particular user, wherein the personalized model is established based on implicit actions the particular user takes in response to receiving previous social newsfeeds; and
using the personalized model to triage the data elements within the current social newsfeed.

2. The process of claim 1, wherein the process action of establishing a personalized model for predicting the importance to a particular user of data elements within a current social newsfeed being delivered to the particular user comprises the actions of:
inputting a baseline statistical model for predicting the importance to a generic user of data elements within a given social newsfeed, wherein the baseline statistical model is trained based on explicit actions other users take in response to receiving previous social newsfeeds;
modifying the baseline statistical model by using the implicit actions the particular user takes in response to receiving previous social newsfeeds; and
designating the modified baseline statistical model to be the personalized model.

3. The process of claim 2, wherein the baseline statistical model comprises either:
a Facebook EdgeRank model; or
a learned social newsfeed content and online friend importance model.

4. The process of claim 2, wherein the implicit actions the particular user takes in response to receiving previous social newsfeeds comprise implicit data element relevance feedback signals comprising:
the particular user commenting on a particular social newsfeed data element that they view;
the particular user selecting a “Like” button displayed within a particular social newsfeed data element that they view;
the particular user selecting a link displayed within a particular social newsfeed data element that they view; and
the particular user forwarding a particular social newsfeed data element to another user.

5. The process of claim 2, wherein the other users comprise one or more of:
users who generate newsfeed data elements having one or more words or word phrases in common with newsfeed data elements generated by the particular user; or
users who have one or more online friends in common with the particular user; or
users who have a pattern of explicit actions in common with the particular user, wherein said actions are in response to viewing a social newsfeed.

6. The process of claim 1, wherein,
the implicit actions the particular user takes in response to receiving previous social newsfeeds comprise implicit data element relevance feedback signals, and
the process action of establishing a personalized model for predicting the importance to a particular user of data elements within a current social newsfeed being delivered to the particular user comprises the actions of:
training a user-specific statistical model for predicting the importance to a specific user of data elements within a given social newsfeed, wherein said training is based on said feedback signals; and
designating the user-specific statistical model to be the personalized model.

7. The process of claim 1, wherein the process action of using the personalized model to triage the data elements within the current social newsfeed comprises one of the actions of:
sorting said data elements according to their importance to the particular user as predicted by the personalized model; or
sorting said data elements according to their importance to the particular user, as predicted by the personalized model, along a prescribed dimension of the personalized model; or
sorting said data elements according to their importance to the particular user, as predicted by the personalized model, along a combination of two or more different prescribed dimensions of the personalized model.

8. The process of claim 7, wherein the prescribed dimension and dimensions comprise:
shareability;
comment-worthiness; and
link-interestingness.

9. The process of claim 1, wherein the process action of using the personalized model to triage the data elements within the current social newsfeed comprises one of the actions of:
removing data elements from the current social newsfeed that the personalized model predicts to be unimportant to the particular user; or
removing data elements from the current social newsfeed that the personalized model predicts to be unimportant to the particular user along a prescribed dimension of the personalized model; or
removing data elements from the current social newsfeed that the personalized model predicts to be unimportant to the particular user along a combination of two or more different prescribed dimensions of the personalized model.

10. The process of claim 9, wherein the prescribed dimension and dimensions comprise:
shareability;
comment-worthiness; and
link-interestingness.

11. The process of claim 1, wherein the process action of establishing a personalized model for predicting the importance to a particular user of data elements within a current social newsfeed being delivered to the particular user comprises the actions of:
establishing a default set of rules for filtering newsfeed data elements;
allowing the particular user to employ a Rules Wizard utility to explicitly inspect and customize the default set of rules, resulting in a personalized set of rules; and
designating the personalized set of rules to be the personalized model.

12. The process of claim 11, wherein,
the implicit actions the particular user takes comprise implicit data element relevance feedback signals, and
the process action of establishing a default set of rules for filtering newsfeed data elements comprises one of the actions of:
the particular user employing a Rules Wizard utility to create the default set of rules; or
training the default set of rules based on the implicit data element relevance feedback signals.

13. The process of claim 12, wherein the process action of training the default set of rules based on the implicit data element relevance feedback signals comprises an action of constraining said rules to fit a set of default categories that are specified by the Rules Wizard utility.

14. The process of claim 1, further comprising the actions of:
upon the particular user specifying another user or a group of other users whose activities the particular user is interested in, and the particular user specifying a period of time they are interested in, identifying each of the data elements within the current social newsfeed that were posted by the specified other user or group of other users during the specified period of time; and
using a summarization engine to generate a personalized summary of the identified data elements.

15. The process of claim 14, wherein the summarization engine implements either an extractive summarization method, or a statistical summarization method.

16. The process of claim 14, wherein the process action of using a summarization engine to generate a personalized summary of the identified data elements comprises the actions of:
using the personalized model to triage the identified data elements; and
running the summarization engine on the triaged identified data elements.

17. The process of claim 14, wherein the process action of using a summarization engine to generate a personalized summary of the identified data elements comprises the actions of:
using the personalized model to rank the identified data elements, wherein said ranking assigns an importance score to each identified data element, said score indicating the predicted importance to the particular user of the identified data element; and
running the summarization engine on the identified data elements, wherein the importance score assigned to each identified data element is taken into account by the summarization engine.

18. The process of claim 14, wherein the personalized summary of the identified data elements is structured in a hierarchical manner, further comprising the actions of:
displaying an overview of said personalized summary to the particular user; and
upon the particular user selecting particular content within the overview, displaying more detailed information about the particular content.

19. A computer-implemented process for delivering a current social newsfeed to a user, comprising:
using a computer to perform the following process actions:
collecting implicit actions the user takes in response to receiving previous social newsfeeds;
providing said implicit actions to a social networking application for the establishment of a personalized model for predicting the importance to the user of data elements within the current social newsfeed;
receiving a triaged version of the current social newsfeed from the social networking application, wherein the triaging has been performed using the personalized model; and
displaying the triaged version of the current social newsfeed to the user.

20. A computer-implemented process for triaging a social newsfeed being delivered to a user, comprising:
using a computer to perform the following process actions:
establishing a personalized model for predicting the importance to the user of data elements within a current social newsfeed being delivered to the user, wherein, the personalized model comprises either a statistical model or a decision tree model, and the personalized model is established based on implicit actions the user takes in response to receiving previous social newsfeeds, said actions comprising implicit data element relevance feedback signals comprising:
the user commenting on a particular social newsfeed data element that they view,
the user selecting a “Like” button displayed within a particular social newsfeed data element that they view,
the user selecting a link displayed within a particular social newsfeed data element that they view, and
the user forwarding a particular social newsfeed data element to another user; and
using the personalized model to triage the data elements within the current social newsfeed.
